(19) United States
(12) Patent Application Publication
(10) Pub. No.: US 2022/0063074 A1
(43) Pub. Date: Mar. 3, 2022

(54) Gas Spring for a Fastener Driving Tool

(71) Applicant: Robert Bosch GmbH, Stuttgart (DE)

(72) Inventors: Peter Wierzchon, Morton Grove, IL (US); Ramon Tam, Buffalo Grove, IL (US)

(21) Appl. No.: 17/003,286

(22) Filed: Aug. 26, 2020

(51) Int. Cl. B25C 1/04

(52) U.S. Cl. CPC B25C 1/047; B25C 1/048

(57) ABSTRACT

A hand-held linear fastener driving tool such as a nailer includes a multi-piston gas spring driver mechanism that includes a piston assembly disposed in a gas cylinder. The piston assembly includes an accumulator piston, a striker piston disposed between the accumulator piston and an open end of the cylinder, and a blade that protrudes from the striker piston. The accumulator piston and the striker piston each form a fluid tight seal with the cylinder inner surface. The piston assembly includes a fluid column that extends between the accumulator piston and the striker piston. A gas storage chamber is disposed between the accumulator piston and the closed end. The piston assembly moves as a unit within the cylinder during tool operation.

### BACKGROUND

When working with a material such as wood or concrete, there is a frequent need to attach items to the material for structural, mechanical, plumbing, and electrical installations. Using a linear fastener driving tool, referred to herein as a “fastener driver,” makes efficient work when attaching or connecting items for these applications. Fastener drivers are portable, hand-held tools that drive staples, nails or other linearly driven fasteners into a workpiece.

Fastener drivers use various driving mechanisms to drive the fasteners into a workpiece. For example, some fastener drivers use compressed air from an external or internal compressor as a driving device, whereas other fastener drivers may use electrical energy, a flywheel mechanism or other driving devices known in the art. Although effective, some driving mechanisms may be limited by power, size, weight and cost constraints.

### SUMMARY

Some fastener drivers may use a gas spring as the driving mechanism that generates the motive force that drives the fastener into a workpiece. In a gas spring fastener driving tool, a cylinder filled with compressed gas is used quickly force a piston through a driving stroke, while a driver that is mechanically connected to the piston drives the fastener into the workpiece. The cylinder discharge, piston stroke and impact of the driver with the fastener are collectively referred to as a driving operation. The piston, and thus also the driver, may be returned to the starting, or “ready” position via a reset mechanism before another driving stroke can be made. During the reset operation, the piston compresses the gas within the cylinder, thereby preparing the linear fastener driving tool for another driving operation.

A gas spring driving device offers high-density energy storage, with a low weight, compact size that can be readily released to drive a fastener. However, such drivers may experience a loss of gas charge over time. A loss of gas charge has the effect that the fastener driver is unable to fully drive a fastener to its desired depth. Moreover, for safety reasons, replenishment of gas charge requires the power tool be taken to a service center. Alternatively, the fastener driver may be scrapped because, in some cases, the entire gas cylinder and drive module are fully integrated and it is not economically viable to service the fastener driver. In other cases, the fastener driver is scrapped because the fastener driver is non-serviceable by design. Thus, for the user, a loss of gas charge may lead to a high level of dissatisfaction.

There are three substantial contributors to the gas cylinder leakage.

The first contributor to gas cylinder leakage is related to the lifter mechanism. In particular, the lifter mechanism transmits lateral loads into the piston seals, even though great effort is made to minimize this in the mechanical design. Strategies for limiting transmission of lateral loads include a) making the singular piston overly tall and providing wide guide seal spacing; b) adding a connecting pin to the piston to allow it to rotate relative to the driver blade; c) increasing the guide seal preload to limit compression on the gas seal; and/or d) holding tight manufacturing tolerances between the piston axis and the lifter device. Because the single piston design needs to withstand side loads, the primary gas seal and guide seals typically have a higher stiffness, leading to excessive frictional losses and wear of the cylinder and seals.

The second contributor to gas cylinder leakage is related to piston seal lubrication. Gas spring driving devices typically require minimizing leakage of the fixed quantity of pressurized gas to atmospheric pressure, so the piston seals are typically lubricated with high viscosity grease, such as silicon grease during the assembly of the tool. The lubricant will be swept away over time, and may leave only a degraded grease film to contain the gas charge. In addition, the lubricant itself leads to friction losses, which may result in reduced power output, or a design in which the gas cylinder is oversized. A further deficiency of some current designs is that the single piston is exposed to the atmosphere. Such exposure may allow contamination of the lubricant. For example, wood, drywall or concrete dust may eventually migrate into the lubricant and eventually into the gas seals. Over time, the contamination can lead to seal degradation resulting in a gradual loss of gas charge. Countermeasures such as foam filters, or labyrinth air path are used to minimize this contamination, but such countermeasure leave the piston bottom exposed to the working environment.

The third contributor to gas cylinder leakage is related to use of a pressurized gas reservoir that has a mechanical barrier with atmospheric pressure. This arrangement creates a gas-to-gas pressure differential, such that there is always a potential for gas leakage, which is irreversible.

An improved gas spring fastener driver that addresses the loss of gas charge over time is described herein. In particular, a fastener driver that includes a multi-piston gas spring driving device is disclosed that minimizes or prevents loss of the gas charge over time. In addition, the multi-piston gas spring driving device optimizes the primary gas spring functions.

The multi-piston gas spring fastener driver includes gas cylinder having an accumulator piston and a striker piston. The accumulator piston is a free-floating piston, and is disposed in the cylinder in equilibrium and with no lateral mechanical loads, whereby sealing of the gas chamber of the cylinder is optimized. The striker piston is disposed in the cylinder in spaced relation to the accumulator piston, and is optimized for transmitting the kinetic energy of the gas spring into the fastener. A volume of fluid is disposed in the intermediate space between the accumulator piston and the striker piston. The volume of fluid serves as a spacer that maintains a separation between the accumulator piston and the striker piston. For example, a fluid such as oil may be used to provide the fluid spacer that separates the two pistons. With a fluid such as oil or ethylene glycol being essentially incompressible, both pistons translate at the same time, without any of the striker piston lateral forces being transmitted to the accumulator piston. The accumulator piston and the striker piston function independently, allowing each to be optimized

The accumulator piston and the striker piston each include seals that ensure that the accumulator gas storage chamber is not in continuous fluidic communication with the displacement volume of the striker piston within the cylinder. The gas storage and fluid spacer chambers are permanently separated by a moveable barrier, which is the accumulator piston. The separation of the accumulator piston from the striker piston via the fluid spacer allows the seals of the accumulator piston to be continuously lubricated in oil, which is not swept away by the guide seals. Seal technology also shows that it is easier to create a reliable dynamic seal between gas and liquid, than between gas and gas. The presence of the volume of liquid between the accumulator piston and the striker piston may also reduce the negative impact of any particulate contaminants, since the small quantity of contaminants that may migrate beyond the striker piston seals and into the fluid chamber would be greatly diluted and have a comparatively negligible effect on the gas seal.

In some embodiments, the accumulator and striker pistons may have exactly the same area ratio. This allows for a compact package and a relatively small volume of fluid to be introduced between the accumulator piston and striker piston. The one-to-one area ratio of the accumulator and striker pistons also allows the gas-to-fluid pressure differential to be zero.

In addition, there are distinct advantages in having the area ratio of the accumulator and striker pistons configured so that the area of the accumulator piston is greater than the area of the striker piston, or alternatively, so that the area of the accumulator piston is less than the area of the striker piston. These non-one-to-one area ratio configurations can be used to tailor the striker piston velocity or create a physical arrangement where the accumulator and striker pistons are not concentric, but can be in any orientation, one example including having non-perpendicular, non-intersecting axes, as long as the displacement chambers are communicating using the working fluid. Such an arrangement may provide the desired performance characteristic ergonomics and tool balance.

In some aspects, a fastener driver mechanism for a fastener driving tool includes a driver mechanism housing. The driver mechanism housing includes a housing sidewall that has a closed shape when viewed in cross-section, a housing closed end disposed at a first end of the housing sidewall, and a housing open end disposed at a second end of the housing sidewall. The fastener driver mechanism includes an accumulator piston disposed in the driver mechanism housing between the housing open end and the housing closed end. The accumulator piston includes a first seal that contacts, and forms a seal with, an inner surface of the housing sidewall. The accumulator piston is configured to move relative to the housing sidewall along a first axis. The fastener driver mechanism includes a striker piston disposed in the driver mechanism housing between the accumulator piston and the housing open end. The striker piston includes a second seal that contacts, and forms a seal with, the inner surface of the housing sidewall. The striker piston is configured to move relative to the housing sidewall along a second axis. In addition, the fastener driver mechanism includes a blade that protrudes from an open end-facing surface of the striker piston, the blade configured to engage with, and apply a driving force to, a fastener upon operation of the fastener driving tool. A gas storage chamber is defined between the accumulator piston, the housing closed end and the housing sidewall. A fluid chamber is defined between the striker piston, the accumulator piston and the housing sidewall. The fluid chamber is filled with a fluid. The first seal is configured to prevent fluid communication between the gas storage chamber and the fluid chamber, and the second seal is configured to prevent fluid communication between the fluid chamber and the housing open end.

In some embodiments, the fluid is a liquid.

In some embodiments, the fluid is an oil.

In some embodiments, the striker piston is a disk and includes a fluid chamber-facing surface, the open end-facing surface that is opposed to the fluid chamber-facing surface, and a side surface that extends between the fluid chamber-facing surface and the open end-facing surface. The second axis is perpendicular to the open end-facing surface and the fluid-chamber facing surface, and the second seal extends along a circumference of the side surface.

In some embodiments, the accumulator piston includes a hollow body that includes a piston sidewall and a piston closed end disposed at one end of the piston sidewall. An outer surface of the piston sidewall faces the housing sidewall inner surface. The first axis is parallel to the piston sidewall, and the first seal extends along a circumference of the piston sidewall outer surface.

In some embodiments, the housing sidewall is a cylinder that includes a first cylinder portion having a first diameter, and a second cylinder portion having a second diameter. The accumulator piston is disposed in the first cylinder portion, the striker piston is disposed in the second cylinder portion. In some embodiments, the first diameter is equal to the second diameter. In some embodiments, the first diameter is greater than the second diameter. In some embodiments, the first diameter is less than the second diameter.

In some embodiments, the first axis is co-linear with the second axis.

In some embodiments, the first axis is non-co-linear with the second axis.

In some embodiments, the first axis is perpendicular to the second axis.

In some embodiments, the housing sidewall is a cylinder. In addition, the driver mechanism housing includes a first cylinder portion and a second cylinder portion. The fluid chamber connects, and provides fluid communication between, the first cylinder portion and the second cylinder portion. The accumulator piston is disposed in the first cylinder portion, and the striker piston is disposed in the second cylinder portion.

In some embodiments, the first cylinder portion adjoins the second cylinder portion.

In some embodiments, the first cylinder portion is remote from the second cylinder portion, and the fluid chamber includes a passageway that extends between the first cylinder portion and the second cylinder portion.

In some embodiments, the fastener driver mechanism includes a pressurized gas reservoir that communicates with, and supplies pressurized gas to, the gas storage chamber.

In some embodiments, the blade comprises a rack that extends in parallel to the second axis and is configured to engage with a pinion gear of a fastener driver reset mechanism.

In some aspects, a hand-held fastener driving tool includes a tool housing having a handle, and a fastener driver mechanism disposed in the tool housing. The fastener driver mechanism includes a driver mechanism housing having a housing sidewall that forms a closed shape when viewed in cross-section, a housing closed end disposed at a first end of the housing sidewall, and a housing open end disposed at a second end of the housing sidewall. The fastener driver mechanism includes an accumulator piston disposed in the driver mechanism housing between the housing open end and the housing closed end. The accumulator piston includes a first seal that contacts, and forms a seal with, the inner surface of the housing sidewall. The accumulator piston is configured to move relative to the housing sidewall along a first axis. The fastener driver mechanism includes a striker piston disposed in the driver mechanism housing between the accumulator piston and the housing open end. The striker piston includes a second seal that contacts, and forms a seal with, the inner surface of the housing sidewall. The striker piston is configured to move relative to the housing sidewall along a second axis. The fastener driver mechanism also includes a blade that protrudes from an open end-facing surface of the striker piston. The blade is configured to engage with, and apply a driving force to, a fastener upon operation of the fastener driving tool. A gas storage chamber is defined between the accumulator piston, the housing closed end and the housing sidewall. A fluid chamber is defined between the striker piston, the accumulator piston and the housing sidewall. The fluid chamber is filled with a fluid. The first seal is configured to prevent fluid communication between the gas storage chamber and the fluid chamber, and the second seal is configured to prevent fluid communication between the fluid chamber and the housing open end.

In some embodiments, the fluid is a liquid.

In some embodiments, the housing sidewall is a cylinder that includes a first cylinder portion having a first diameter, and a second cylinder portion having a second diameter. The accumulator piston is disposed in the first cylinder portion, the striker piston is disposed in the second cylinder portion. In some embodiments, the first diameter is equal to the second diameter. In some embodiments, the first diameter is greater than the second diameter. In some embodiments, the first diameter is less than the second diameter.

In some embodiments, the first axis is co-linear with the second axis.

In some embodiments, the first axis is non-co-linear with the second axis.

In some embodiments, the housing sidewall includes a first portion and a second portion, the accumulator piston is disposed in the first portion, the striker piston is disposed in the second portion, and the first portion is remote from the second portion.

In some embodiments, the fluid in the fluid chamber provides a fluid column, and the accumulator piston, the fluid column, the striker piston and the blade are configured to move together as a unit within the driver mechanism housing.

### BRIEF DESCRIPTION OF THE FIGURES

FIG. 1 is a side cross-sectional view of a wireless, hand-held, linear fastener driving tool that includes a multi-piston gas spring driving device.

FIG. 2 is cross sectional view of the cylinder of the multi-piston gas spring driving device of FIG. 1.

FIG. 3 is a cross sectional view of another embodiment of the cylinder.

FIG. 4 is a cross sectional view of another embodiment of the cylinder.

FIG. 5 is a cross sectional view of another embodiment of the cylinder.

FIG. 6 is a schematic view of another embodiment of the cylinder in which portions of the cylinder, shown in cross section, are remote from each other and connected by a fluid passageway shown in broken lines.

FIG. 7 is a schematic view of another embodiment of the cylinder in which portions of the cylinder, shown in cross section, are remote from each other and connected by a fluid passageway shown in broken lines, and in which two accumulator pistons are employed.

FIG. 8 is a graph of striker piston stroke versus force on the striker piston for various configurations of the cylinder of FIG. 7.

### DETAILED DESCRIPTION

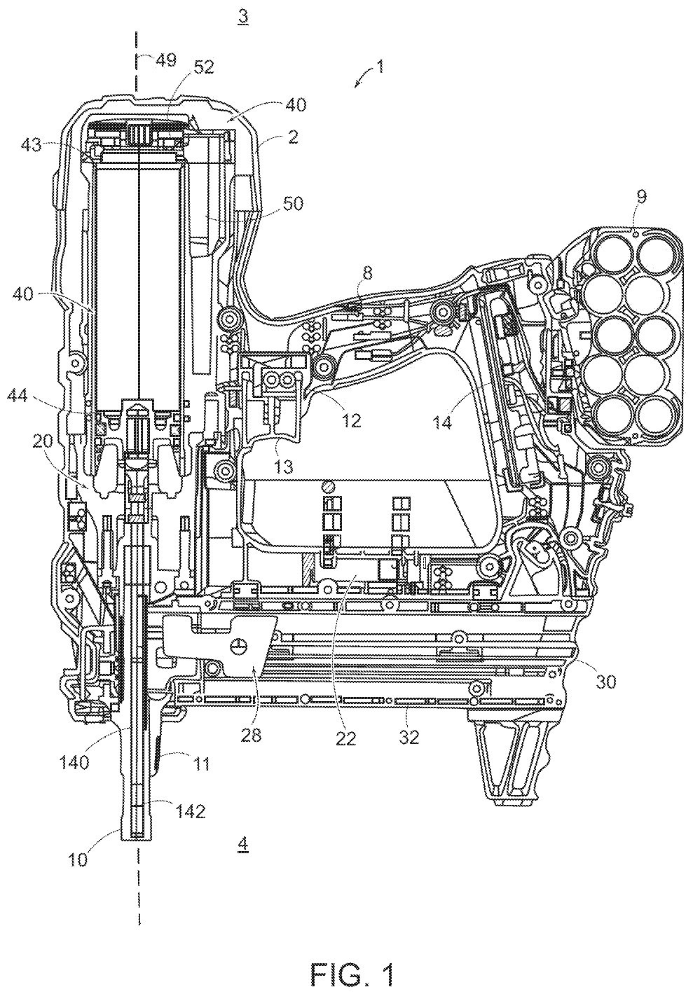

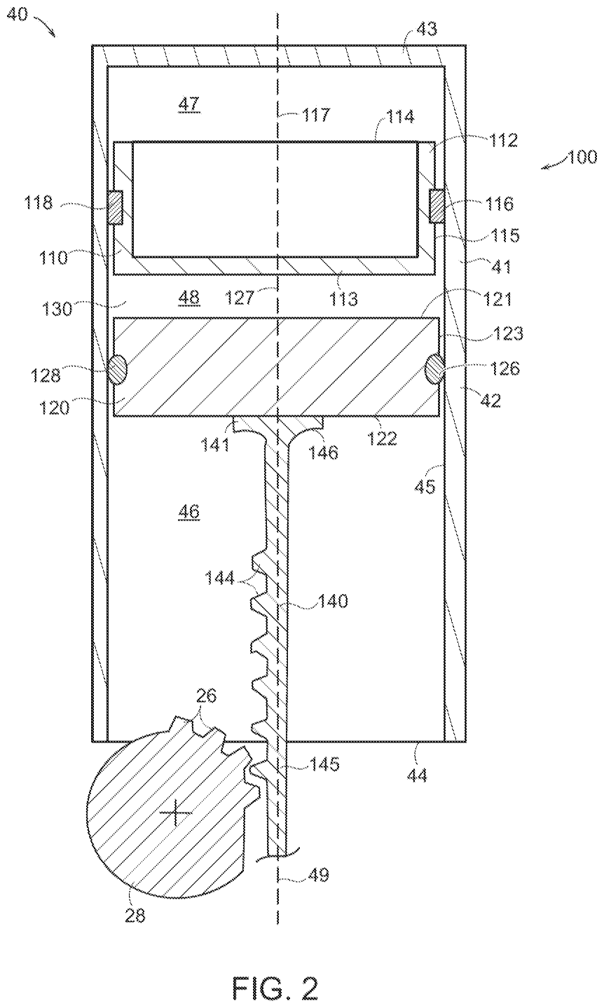

Referring to FIGS. 1 and 2, the power tool 1 is a hand-held, linear fastener driving tool. In the illustrated embodiment, the power tool is a gas nailer that is designed to linearly drive fasteners such as nails and staples. The power tool 1 includes a tool housing 2 that forms a handle 8 that resides in an upper mid portion of the power tool 1. The tool housing 2 supports and/or encloses several mechanisms and devices, including a fastener driver mechanism 40 that is positioned forward of the handle 8 to provide the front of the tool 2, and a fastener driver reset mechanism 20 that is disposed below the fastener driver mechanism 40 along the front of the tool 2. Also included are a fastener feed mechanism 28 disposed rearward of the fastener driver reset mechanism 20, and a fastener magazine 30 disposed rearward of the fastener feed mechanism 28 to provide the bottom of the tool 2. The fastener driver mechanism 40 is a multi-piston gas spring driver that offers high-density energy storage, low weight and compact size as compared to some other types of fastener driver mechanisms. The fastener driver mechanism 40 will be described in detail below.

References to direction including “above”, “below”, “front”, “rear”, “top”, “bottom”, etcetera, are made with respect to the orientation of the power tool 1 shown in FIG. 1 for purposes of description. It is understood that the power tool 1 is not limited to the orientation shown FIG. 1.

The fastener feed mechanism 28 and corresponding fastener magazine 30 are disposed below the handle 8 and battery pack 9. The power tool 1 includes a fastener exit portion 10 and a guide body 11 that protrude from the tool housing 2 below the fastener driver reset mechanism 20. The fastener feed mechanism 28 is generally in parallel with the handle 8 so as to communicate with the guide body 11. An electric motor 22 that is used to drive the fastener driver reset mechanism 20 resides between the handle 8 and the fastener magazine 30. The electric motor 22 has an output that drives a gear set (not shown). An output of the gear set drives the fastener driver reset mechanism 20. The electric motor 22 may be, for example, an electric brushless DC motor.

The fastener magazine 30 includes a magazine housing 32, and a fastener track (not shown) is disposed in the magazine housing 32. The individual fasteners (for example, nails) are moveable within the fastener magazine 30. A feeder carriage (not shown) is disposed in the magazine housing 32, and is used to feed an individual fastener from the fastener magazine 30 into the fastener driver mechanism 40. In the illustrated embodiment, the feeder carriage positions a fastener in a location within the guide body 11 that is coincident with the path of a driver member (e.g., a blade 140) of the fastener driver mechanism 40, so that when the blade 140 moves through a driving stroke, its driving end will intercept the fastener and carry that fastener to the fastener exit portion 10, at the bottom portion of the tool's exit area.

The handle 8 serves as a hand grip. The handle 8 is hollow and a trigger switch 12 is disposed in the handle 8. The trigger switch 12 is activated by a trigger 13 that protrudes from a bottom-facing surface of the handle 8. As can been seen in FIG. 1, the handle 8 is shaped and dimensioned to be gripped by a human hand, and the trigger 13 is configured to be actuated by a user's finger while gripping the handle 8.

The power tool 1 includes a printed circuit board 14 that is disposed in the interior space of the handle 8. The printed circuit board 14 supports a controller (not shown). The trigger switch 12 and other devices provide inputs to the controller. The controller may include a microprocessor or a microcomputer device that acts as a processing circuit. At least one memory circuit will may also be part of the controller, including Random Access Memory (RAM) and Read Only Memory (ROM) devices. To store user-inputted information (if applicable for a particular tool model), a non-volatile memory device may be included, such as EEPROM, NVRAM, or a Flash memory device.

In addition, the power tool 1 includes a detachable battery pack 9 that connects to a rear end of the handle 8. The battery pack 9 provides electrical power for the controller, the electric motor 22 and other electrical devices within the power tool 1. The battery pack 9 is rechargeable. To this end, the battery pack 9 may be selectively detachable from the handle 8 to allow recharging within a dedicated charging device.

The fastener driver mechanism 40 is a gas spring-type driving mechanism that includes a cylinder 41 that forms a portion of a housing of the fastener driver mechanism 40 and a piston assembly 100 disposed in the cylinder 41. The piston assembly 100 is movable within the cylinder 41 along a cylinder longitudinal axis 49 that extends between the top 3 and bottom 4 of the tool housing 2. The fastener driver mechanism 40 includes a gas reservoir 50 that communicates with an interior space 46 of the cylinder 41 and contains a fixed volume of non- flammable gas. A blade 140 protrudes from the piston assembly 100 so as to extend out of the cylinder 41. The elements of the fastener driver mechanism 40 will now be described in detail.

The cylinder 41 includes a cylinder sidewall 42. In the illustrated embodiment, the cylinder sidewall 42 is an elongate tube having a circular cross-section, but the cross-sectional shape of the cylinder 41 is not limited to being circular. The cylinder 41 has a closed cylinder first end 43, and an open cylinder second end 44 that is opposed to the cylinder first end 43 and is open to the atmosphere. The cylinder 41 includes the cylinder longitudinal axis 49 that extends along a centerline of the cylinder sidewall 42 and through the cylinder first and second ends 43, 44. The sidewall 42 has a uniform diameter along the longitudinal axis 49. The interior space 46 of the cylinder 41 is defined between the cylinder sidewall 42 and the cylinder first and second ends 43, 44.

The piston assembly 100 is disposed in the cylinder interior space 46 and includes an accumulator piston 110, a striker piston 120, a fluid column 130 disposed between the accumulator piston 110 and the striker piston 120, and a blade 140 that protrudes from the striker piston 120. The accumulator piston 110, the fluid column 130, the striker piston 120, and the blade 140 are configured to translate (e.g., slide) together as a unit along the cylinder longitudinal axis 49.

The accumulator piston 110 is disposed in the cylinder interior space 46 between the cylinder first end 43 and the cylinder second end 44. The accumulator piston 110 may have a cup-shaped, hollow body that includes a piston sidewall 112, a piston closed end 113 disposed at one end of the piston sidewall 112 and a piston open end 114 disposed at an opposed end of the piston sidewall 112. The piston sidewall 112 is a short tube having a cross-sectional shape and dimensions that conform to the shape and dimensions of the cylinder sidewall inner surface 45. Thus, in the illustrated embodiment, the piston sidewall 112 has a circular cross section and a clearance fit with respect to the cylinder sidewall inner surface 45. The accumulator piston 110 is oriented in the cylinder 41 so that the piston sidewall outer surface 115 faces the cylinder sidewall 42, the piston closed end 113 faces the striker piston 120, and the piston open end 114 faces the closed cylinder first end 43. A longitudinal axis 117 of the accumulator piston 110 is parallel to the piston sidewall 112 and is co-linear with the cylinder longitudinal axis 49.

The accumulator piston 110 includes an annular, elastic first seal 118 that is disposed in a first groove 116. The first groove 116 extends about the circumference of the piston sidewall outer surface 115. The first seal 118 is shaped and dimensioned to form a fluid tight seal with the cylinder sidewall inner surface 45.

A gas storage chamber 47 is disposed in the cylinder 41 between the accumulator piston 110 and the closed cylinder first end 43. In particular, the gas storage chamber 47 is a portion of the cylinder interior space 46 that is segregated from the remainder of the cylinder interior space 46 by the first seal 118. The gas storage chamber 47 is in fluid communication with the gas reservoir 50, for example via a passageway 52.

The striker piston 120 is disposed in the cylinder interior space 46 between the accumulator piston 110 and the open cylinder second end 44. The striker piston 120 may be a cylindrical disk and includes a generally planar first surface 121 that faces the accumulator piston 110, a generally planar second surface 122 that faces the cylinder second end 44, and a curved side surface 123 that extends between the first and second surfaces 121, 122, and faces the cylinder sidewall. The striker piston 120 has a cross-sectional shape and dimensions that conform to the shape and dimensions of the cylinder sidewall inner surface 45. Thus, in the illustrated embodiment, the side surface 123 has a circular cross section and the side surface 123 has a clearance fit with respect to the cylinder sidewall inner surface 45. The striker piston 120 has a low profile, in that a longitudinal dimension of the side surface 123 is small relative to the diameters of the first and second surfaces 121, 122. The striker piston second surface 122 is exposed to the atmosphere. A longitudinal axis 127 of the striker piston 120 is parallel to the side surface 123 and is co-linear with the cylinder longitudinal axis 49.

The striker piston 120 includes an annular, elastic second seal 128 that is disposed in a second groove 126. The second groove 126 extends about the circumference of the side surface 123. The second seal 128 is shaped and dimensioned to form a fluid tight seal with the cylinder sidewall inner surface 45.

A fluid chamber 48 is disposed in the cylinder 41 between the accumulator piston 110 and the striker piston 120. In particular, the fluid chamber 48 is a portion of the cylinder interior space 46 that is segregated from the gas storage chamber 47 by accumulator piston 110 and the first seal 118, and from the remainder of the cylinder interior space 46 by the striker piston 120 and the second seal 128. An incompressible fluid is disposed in the fluid chamber 48. In the illustrated embodiment, the fluid chamber 48 is completely filled with a liquid, for example an oil or ethylene glycol.

The liquid disposed in the fluid chamber 48 serves as the fluid column 130 that maintains a desired spacing between the accumulator piston 110 and the striker piston 120. In addition, the fluid column 130 serves to decouple the accumulator piston 110 from lateral loads experienced by the striker piston 120 during operation of the power tool 1.

The gas storage chamber 47 and the fluid chamber 48 are permanently separated by the movable accumulator piston 110, and the first seal 118 is continuously lubricated in oil not swept away by the second seal 128.

The blade 140 serves as the portion of the fastener driver mechanism 40 that contacts the fastener 32 and drives the fastener 32 into a workpiece (not shown) upon operation of the fastener driving tool. The blade 140 protrudes from the striker piston second surface 122, e.g., from the end of the striker piston 120 that faces the cylinder open end 44. The blade 140 is an elongate, solid cylindrical rod having a blade first end 141 that is joined to the piston 90 via, for example, a threaded connection, and a blade second end 142 that is opposed to the blade first end 141. The blade 140 includes a blade longitudinal axis 145 that extends between the blade first and second ends 141, 142, and is co-linear with the cylinder longitudinal axis 49.

The blade first end 141 includes an external thread (not shown) that engages with a corresponding internal thread (not shown) provided in a central blind hole provided in the striker piston second surface 122. The external thread terminates at an integrally-formed annular protrusion 146 that abuts the piston second surface 122 when the blade 140 is fully engaged with, and secured to, the striker piston 120. In some embodiments, the blade 140 includes a row of teeth 144 that form a rack that is configured to engage with the teeth 26 a pinion gear 28 of the fastener driver reset mechanism 20.

In use, the fastener driver reset mechanism 20 lifts the piston assembly 100 and compresses the gas within the gas reservoir 50 to a high pressure. This configuration corresponds to a retracted position of the striker piston 120 and a “ready to fire” state of the power tool 1. When the user pulls the trigger 13 (e.g., “fires the tool”), the motor 22 rotates, releasing the piston assembly 100 including the blade 140. The compressed gas within the cylinder 41 expands and drives the piston assembly 100 within the tool housing 2, whereby the blade 140 advances from the tool housing 2 in the driving stroke. While being advanced, the blade 140 receives a fastener from the fastener feed mechanism 28 and propels the fastener into a workpiece. Upon completion of the driving stroke, which corresponds to an advanced position of the striker piston 120, the fastener driver reset mechanism 20 returns the piston assembly 100 and blade 140 to the ready-to-fire state, compressing the fixed volume of gas to a higher pressure, in readiness for a subsequent nailing operation.

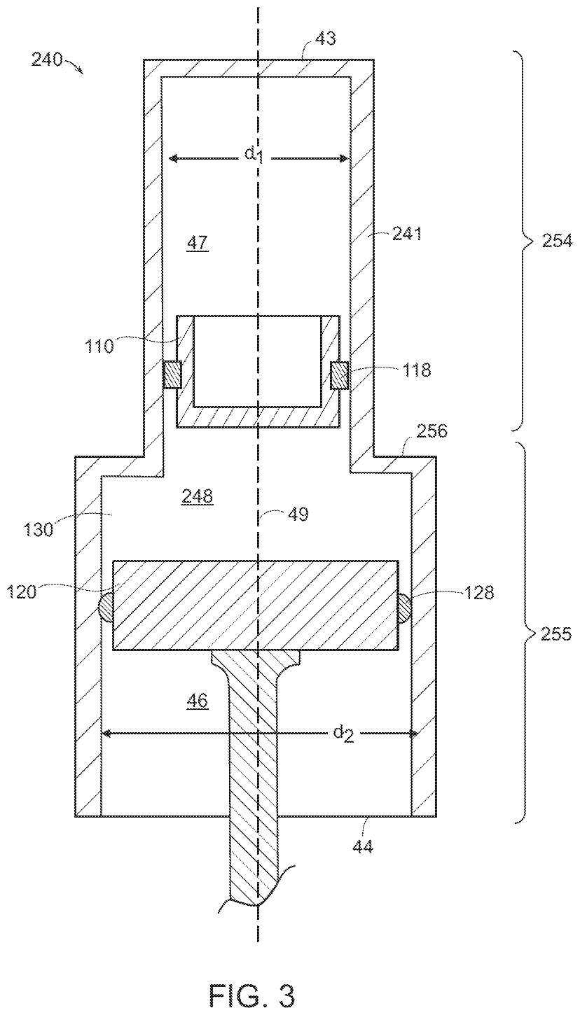

Referring to FIG. 3, an alternative embodiment fastener driver mechanism 240 is similar to the fastener driver mechanism 40 of FIG. 2, and common elements are referred to with common reference numbers. The fastener driver mechanism 240 of FIG. 3 differs from the earlier described embodiment in that the fastener driver mechanism 240 has a cylinder 241 of non-uniform diameter along the longitudinal axis 49. In particular, the cylinder 241 has a first diameter d1 in a first portion 254 of the cylinder 241 that adjoins the cylinder closed end 43, and a second diameter d2 in second portion 255 of the cylinder 241 that adjoins the cylinder open end 44. The second diameter d2 is greater than the first diameter d1, and a shoulder 256 is disposed at the transition between the first diameter d1 and the second diameter d2. The accumulator piston 110 is disposed in the cylinder first portion 254, the striker piston 120 is disposed in the cylinder second portion 255, and the fluid column 130 is disposed in the fluid chamber 248, which includes the shoulder 256. Since the area of the accumulator piston 110 is less than the area of the striker piston 120, the fastener driver mechanism 240 generates a greater blade force than the fastener driver mechanism 40 shown in FIG. 2.

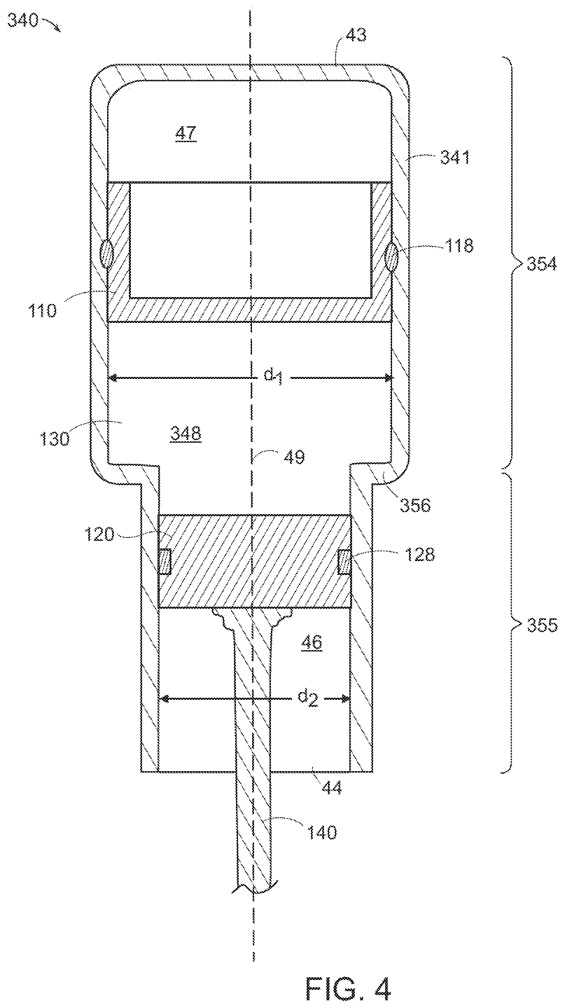

Referring to FIG. 4, another alternative embodiment fastener driver mechanism 340 is similar to the fastener driver mechanism 40 of FIG. 2, and common elements are referred to with common reference numbers. The fastener driver mechanism 340 of FIG. 4 differs from the earlier described embodiment in that the fastener driver mechanism 340 has a cylinder 341 of non-uniform diameter along the longitudinal axis 49. In particular, the cylinder 341 has a first diameter d1 in a first portion 354 of the cylinder 341 that adjoins the cylinder closed end 43, and a second diameter d2 in second portion 355 of the cylinder 241 that adjoins the cylinder open end 44. The second diameter d2 is less than the first diameter d1, and a shoulder 356 is disposed at the transition between the first diameter d1 and the second diameter d2. The accumulator piston 110 is disposed in the cylinder first portion 354, the striker piston 120 is disposed in the cylinder second portion 355, and the fluid column 130 is disposed in the fluid chamber 348, which includes the shoulder 356. Since the area of the accumulator piston 110 is greater than the area of the striker piston 120, the fastener driver mechanism 340 generates a greater blade velocity than the fastener driver mechanism 40 shown in FIG. 2.

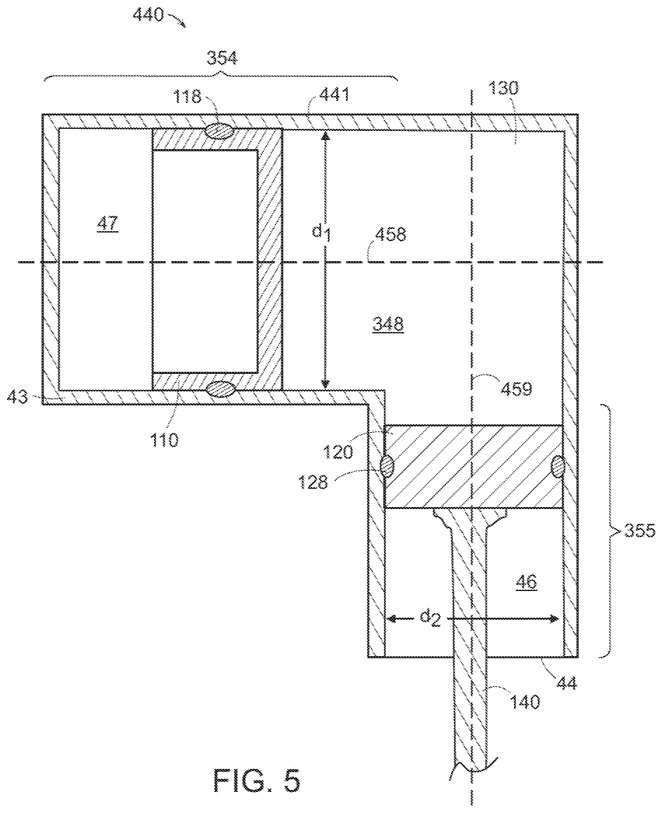

Referring to FIG. 5, another alternative embodiment fastener driver mechanism 440 is similar to the fastener driver mechanism 340 of FIG. 4, and common elements are referred to with common reference numbers. The fastener driver mechanism 440 of FIG. 5 differs from the fastener driver mechanism 340 in that the fastener driver mechanism 440 has a cylinder 441 in which the first portion 354 of the cylinder 441 has a first axis 458 that is coaxial with the longitudinal axis 117 of the accumulator piston 110, the second portion 355 of the cylinder 441 has a second axis 459 that is coaxial with the longitudinal axis 127 of the striker piston 120, and the first axis 458 is non-colinear with respect to the second axis 459. For example, in the illustrated embodiment, the first axis 458 is perpendicular to the second axis 459.

Like the previous embodiment, the cylinder 341 has a first diameter d1 in a first portion 354 of the cylinder 241 that adjoins the cylinder closed end 43, and a second diameter d2 in second portion 355 of the cylinder 241 that adjoins the cylinder open end 44. The second diameter d2 is less than the first diameter d1. However, the fastener driver mechanism 440 may include a cylinder 441 in which the second diameter d2 is greater than the first diameter d1 or, alternatively, the fastener driver mechanism 440 may include a cylinder 441 in which the first and second diameters d1, d2 are equal.

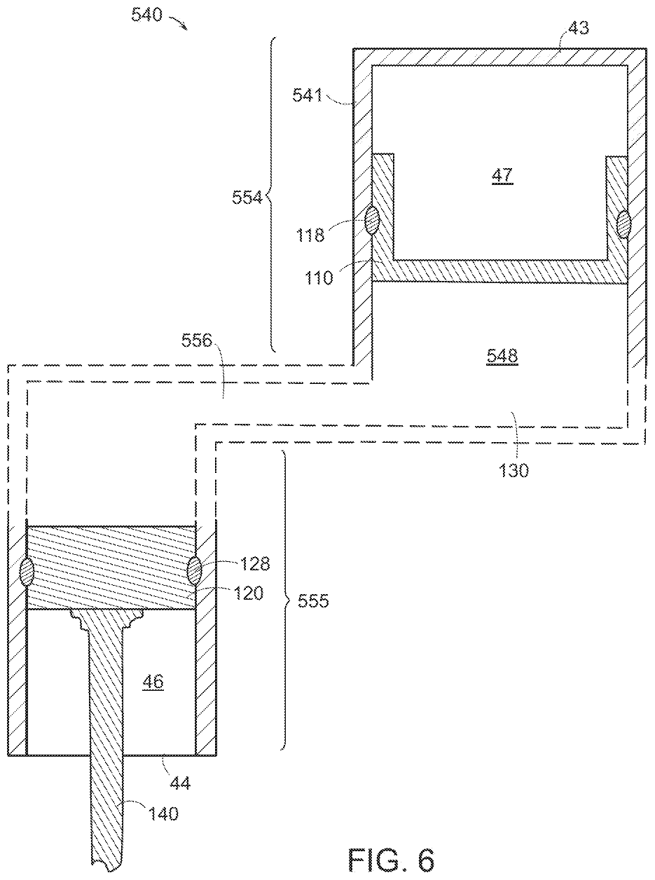

Referring to FIG. 6, another alternative embodiment fastener driver mechanism 540 is similar to the fastener driver mechanism 40 of FIG. 2, and common elements are referred to with common reference numbers. The fastener driver mechanism 540 of FIG. 6 differs from the fastener driver mechanism 40 of FIG. 2 in that cylinder 541 of the fastener driver mechanism 540 has a first cylinder portion 554 that includes the accumulator piston 110, a second cylinder portion 555 that includes the striker piston 120, and the first cylinder portion 554 is remote from the second cylinder portion 555. In some embodiments, a fluid passageway 556 is used to provide a fluid connection between the first and second cylinder portions 554, 555. In addition, the fluid chamber 548 disposed between the accumulator piston 110 and the striker piston 120 includes the fluid passageway 556. Since the first cylinder portion 554 is remote from the second cylinder portion 555, there is increased freedom in designing the overall configuration of the fastener driver mechanism and packaging of components within the tool can be optimized. For example, the balance of the power tool 1 can be improved by strategic placement of the first and second portions 554, 555 of the cylinder 541 within the tool housing 2.

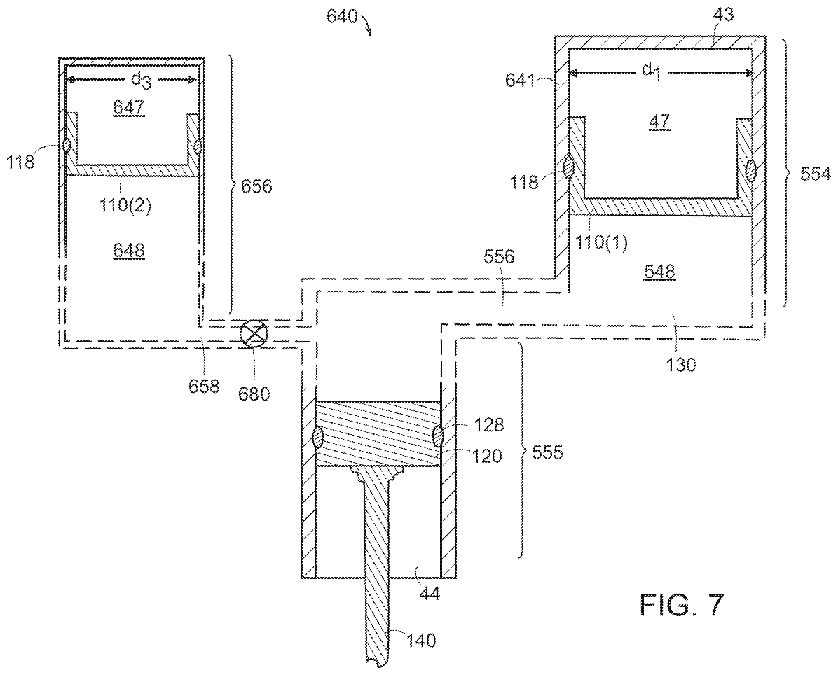

Referring to FIG. 7, another alternative embodiment fastener driver mechanism 640 is similar to the fastener driver mechanism 540 of FIG. 6, and common elements are referred to with common reference numbers. The fastener driver mechanism 640 of FIG. 7 differs from the fastener driver mechanism 540 of FIG. 6 in that the fastener driver mechanism 640 includes multiple accumulator pistons 110(1), 110(2). To that end, the cylinder 641 of the fastener driver mechanism 640 has a first cylinder portion 554 that includes the accumulator piston 110, a second cylinder portion 555 that includes the striker piston 120, and a third cylinder portion 656. The first cylinder portion 554 is remote from the second cylinder portion 555, and the first fluid passageway 556 is used to provide a fluid connection between the first and second cylinder portions 554, 555. In addition, the first fluid chamber 548 disposed between the first accumulator piston 110(1) and the striker piston 120 includes the fluid passageway 556. The third cylinder portion 656 is remote from the first cylinder portion 554 and the second cylinder portion 555. The third cylinder portion 656 includes the second accumulator piston 110(2), which segregates the third cylinder portion 656 into a second gas storage chamber 647 and a second fluid chamber 648 via the seal 118 disposed between the second accumulator piston 110(2) and an inner surface 645 of the third cylinder portion 656. The second gas storage chamber 647 is in fluid communication with the gas reservoir 50. The second fluid chamber 648 is connected to the first fluid chamber 548 via a valve-controlled passageway 658. The first cylinder portion 554 and the second cylinder portion 656 are hydraulically connected, and the first and second accumulator pistons 110(1), 110(2) work together. In the illustrated embodiment, the third cylinder portion 656 can be isolated from the remainder of the cylinder housing 641 by closing the valve 680. Thus the fastener driver mechanism 640 can provide multiple power settings.

The first cylinder portion 554 including the first accumulator piston 110(1) has a first cross sectional diameter d1, and thus provides a first gas charge pressure P1. In addition, the third cylinder portion 656 including the second accumulator piston 110(2) has a third cross sectional diameter d3, and thus provides a second gas charge pressure P2. In the illustrated embodiment, the first diameter d1 is different from the third diameter d3. However, the fastener driver mechanism 640 is not limited to this configuration. For example, in other embodiments, the first and third diameters d1, d3 may be equal and in still other embodiments, the third diameter d3 may be greater than the first diameter d1.

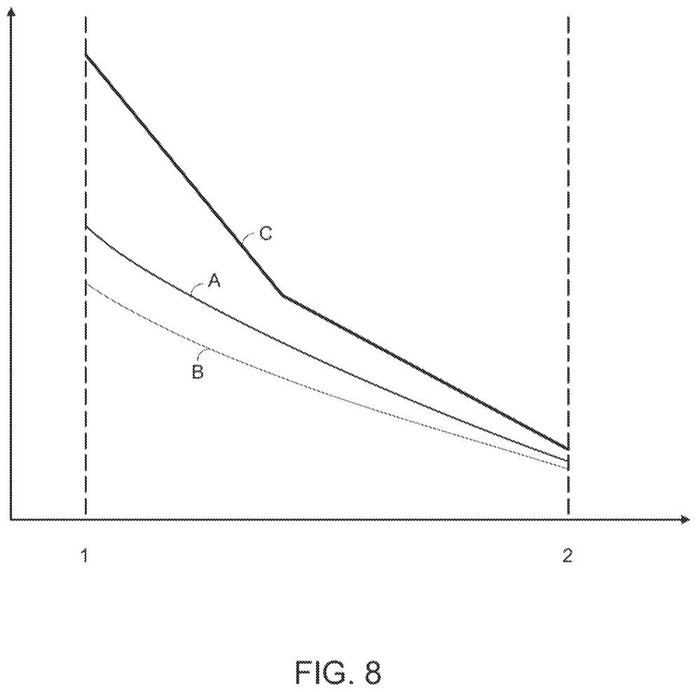

A graph of striker piston stroke (abcissa) versus the force on the striker piston (ordinate) for various configurations of the fastener driver 640 is shown in FIG. 8. In FIG. 8, the striker piston stroke 1 corresponds to the striker piston 120 in the retracted (ready to fire) position, whereas the piston stroke 2 refers to the striker piston 120 in the advanced (fired) position. Curve A represents the cylinder 641 operated using a single accumulator piston 110(1), curve B represents the cylinder 641 operated using both accumulator pistons 110(1), 110(2) having the same gas charge pressure, and curve C represents the cylinder 641 operated using both accumulator pistons 110(1), 110(2) where the gas charge pressure P1 of the first accumulator piston 110(1) is different than the gas charge pressure P2 of the second accumulator piston 110(2).

As seen in FIG. 8, if the cylinder 641 is operated using two accumulator pistons 110(1), 110(2) working together, the combined gas volume is larger, so the curve B is more flat than the curve A, which is associated with the cylinder 641 operated with the valve 680 closed having a single accumulator piston 110(1). Thus, the force on striker piston 120 is more consistent when two accumulator pistons 110(1), 110(2) are employed. If only one accumulator piston 110(1) is allowed to operate (curve A), the gas volume is smaller and the single accumulator piston 110 movers further and creates a higher pressure/striker piston force, but drops to the same end value. If the two accumulator pistons 110(1), 110(2) have different pressures, one accumulator piston will move first and the second accumulator piston will move later, creating the dual slope curve C. This configuration can be used to accelerate the striker piston 120 faster when it is released (e.g., when the tool is fired).

Since the first cylinder portion 554, the second cylinder portion 555 and the third cylinder portion 656 are remote from each other, there is increased freedom in designing the overall configuration of the fastener driver mechanism and packaging of components within the tool can be optimized.

Although the fastener driver mechanism 640 includes two accumulator pistons 110(1), 110(2), it is understood that the fastener driver mechanism 640 is not limited to having two accumulator pistons. The number of accumulator pistons employed may be three or more, and is determined by the requirements of the specific application.

In the illustrated embodiments, the accumulator piston 110 includes a single seal, e.g., the first seal 118, and the striker piston 120 includes a single seal, e.g., the second seal 128. It is understood however, that one or both of the accumulator piston 110 and the striker piston 120 may include multiple seals.

In the illustrated embodiments, the accumulator piston 110 is cup shaped and the striker piston is disk shaped, but the accumulator and striker pistons 110, 120 are not limited to having these shapes. The shape of each of the accumulator and striker pistons 110, 120 is determined by the requirements of the specific application. Moreover, in some embodiments, both the accumulator and striker pistons 110, 120 may have the same shape.

Selective illustrative embodiments of the power tool including the multi-piston fastener driver mechanism are described above in some detail. It should be understood that only structures considered necessary for clarifying the power tool including the multi-piston fastener driver mechanism have been described herein. Other conventional structures, and those of ancillary and auxiliary components of the power tool including the multi-piston fastener driver mechanism, are assumed to be known and understood by those skilled in the art. Moreover, while working examples of the multi-piston fastener driver mechanism have been described above, the power tool and/or the multi-piston fastener driver mechanism are not limited to the working examples described above, but various design alterations may be carried out without departing from the power tool and/or the multi-piston fastener driver mechanism as set forth in the claims.

We claim:

1. A fastener driver mechanism for a fastener driving tool, the fastener driver mechanism comprising
a driver mechanism housing including
a housing sidewall that has a closed shape when viewed in cross-section,
a housing closed end disposed at a first end of the housing sidewall, and
a housing open end disposed at a second end of the housing sidewall,
an accumulator piston disposed in the driver mechanism housing between the housing open end and the housing closed end, the accumulator piston comprising a first seal that contacts, and forms a seal with, an inner surface of the housing sidewall, the accumulator piston being configured to move relative to the housing sidewall along a first axis,
a striker piston disposed in the driver mechanism housing between the accumulator piston and the housing open end, the striker piston comprising a second seal that contacts, and forms a seal with, the inner surface of the housing sidewall, the striker piston being configured to move relative to the housing sidewall along a second axis,
and
a blade that protrudes from an open end-facing surface of the striker piston, the blade configured to engage with, and apply a driving force to, a fastener upon operation of the fastener driving tool,
wherein
a gas storage chamber is defined between the accumulator piston, the housing closed end and the housing sidewall,
a fluid chamber is defined between the striker piston, the accumulator piston and the housing sidewall, the fluid chamber being filled with a fluid,
the first seal is configured to prevent fluid communication between the gas storage chamber and the fluid chamber, and
the second seal is configured to prevent fluid communication between the fluid chamber and the housing open end.

2. The fastener driver mechanism of claim 1, wherein the fluid is a liquid.

3. The fastener driver mechanism of claim 1, wherein the striker piston is a disk and includes
a fluid chamber-facing surface,
the open end-facing surface that is opposed to the fluid chamber-facing surface, and
a side surface that extends between the fluid chamber-facing surface and the open end- facing surface,
wherein
the second axis is perpendicular to the open end-facing surface and the fluid-chamber facing surface, and
the second seal extends along a circumference of the side surface.

4. The fastener driver mechanism of claim 1, wherein
the accumulator piston includes a hollow body that includes a piston sidewall and a piston closed end disposed at one end of the piston sidewall,
an outer surface of the piston sidewall faces the housing sidewall inner surface,
the first axis is parallel to the piston sidewall, and
the first seal extends along a circumference of the piston sidewall outer surface.

5. The fastener driver mechanism of claim 1, wherein the housing sidewall is a cylinder that includes
a first cylinder portion having a first diameter, and
a second cylinder portion having a second diameter, and wherein
the accumulator piston is disposed in the first cylinder portion,
the striker piston is disposed in the second cylinder portion, and
the first diameter is equal to the second diameter.

6. The fastener driver mechanism of claim 1, wherein the housing sidewall is a cylinder that includes
a first cylinder portion having a first diameter, and
a second cylinder portion having a second diameter, and wherein
the accumulator piston is disposed in the first cylinder portion,
the striker piston is disposed in the second cylinder portion, and
the first diameter is greater than the second diameter.

7. The fastener driver mechanism of claim 1, wherein the housing sidewall is a cylinder that includes
a first cylinder portion having a first diameter, and
a second cylinder portion having a second diameter, and wherein
the accumulator piston is disposed in the first cylinder portion,
the striker piston is disposed in the second cylinder portion, and
the first diameter is less than the second diameter.

8. The fastener driver mechanism of claim 1, wherein the first axis is co-linear with the second axis.

9. The fastener driver mechanism of claim 1, wherein the first axis is non-co-linear with the second axis.

10. The fastener driver mechanism of claim 9, wherein
the housing sidewall is a cylinder, and
the driver mechanism housing includes a first cylinder portion, a second cylinder portion, and the fluid chamber connects, and provides fluid communication between, the first cylinder portion and the second cylinder portion, wherein the accumulator piston is disposed in the first cylinder portion, the striker piston is disposed in the second cylinder portion.

11. The fastener driver mechanism of claim 10, wherein the first cylinder portion adjoins the second cylinder portion.

12. The fastener driver mechanism of claim 10, wherein the first cylinder portion is remote from the second cylinder portion, and the fluid chamber includes a passageway that extends between the first cylinder portion and the second cylinder portion.

13. The fastener driver mechanism of claim 1, comprising a pressurized gas reservoir that communicates with, and supplies pressurized gas to, the gas storage chamber.

14. The fastener driver mechanism of claim 1, wherein the blade comprises a rack that extends in parallel to the second axis and is configured to engage with a pinion gear of a fastener driver reset mechanism.

15. The fastener driver mechanism of claim 1, wherein the fluid in the fluid chamber provides a fluid column, and the accumulator piston, the fluid column, the striker piston and the blade are configured to move together as a unit within the driver mechanism housing.

16. A hand-held fastener driving tool comprising:
a tool housing including a handle,
a fastener driver mechanism disposed in the tool housing, the fastener driver mechanism comprising
a driver mechanism housing including
a housing sidewall that forms a closed shape when viewed in cross-section,
a housing closed end disposed at a first end of the housing sidewall, and
a housing open end disposed at a second end of the housing sidewall,
an accumulator piston disposed in the driver mechanism housing between the housing open end and the housing closed end, the accumulator piston comprising a first seal that contacts, and forms a seal with, the inner surface of the housing sidewall, the accumulator piston being configured to move relative to the housing sidewall along a first axis,
a striker piston disposed in the driver mechanism housing between the accumulator piston and the housing open end, the striker piston comprising a second seal that contacts, and forms a seal with, the inner surface of the housing sidewall, the striker piston being configured to move relative to the housing sidewall along a second axis,
and
a blade that protrudes from an open end-facing surface of the striker piston, the blade configured to engage with, and apply a driving force to, a fastener upon operation of the fastener driving tool,
wherein
a gas storage chamber is defined between the accumulator piston, the housing closed end and the housing sidewall,
a fluid chamber is defined between the striker piston, the accumulator piston and the housing sidewall, the fluid chamber being filled with a fluid,
the first seal is configured to prevent fluid communication between the gas storage chamber and the fluid chamber, and
the second seal is configured to prevent fluid communication between the fluid chamber and the housing open end.

17. The fastener driving tool of claim 16, wherein the fluid is a liquid.

18. The fastener driving tool of claim 16, wherein the housing sidewall is a cylinder that includes
a first cylinder portion having a first diameter, and
a second cylinder portion having a second diameter, and wherein
the accumulator piston is disposed in the first cylinder portion,
the striker piston is disposed in the second cylinder portion, and
the first diameter is equal to the second diameter.

19. The fastener driving tool of claim 16, wherein the housing sidewall is a cylinder that includes
a first cylinder portion having a first diameter, and
a second cylinder portion having a second diameter, and wherein
the accumulator piston is disposed in the first cylinder portion,
the striker piston is disposed in the second cylinder portion, and
the first diameter is greater than the second diameter.

20. The fastener driving tool of claim 16, wherein the housing sidewall is a cylinder that includes
a first cylinder portion having a first diameter, and
a second cylinder portion having a second diameter, and wherein
the accumulator piston is disposed in the first cylinder portion,
the striker piston is disposed in the second cylinder portion, and
the first diameter is less than the second diameter.

21. The fastener driving tool of claim 16, wherein the first axis is non-co-linear with the second axis.

22. The fastener driving tool of claim 20, wherein
the housing sidewall includes a first portion and a second portion,
the accumulator piston is disposed in the first portion,
the striker piston is disposed in the second portion, and
the first portion is remote from the second portion.

23. The fastener driving tool of claim 16, wherein the fluid in the fluid chamber provides a fluid column, and the accumulator piston, the fluid column, the striker piston and the blade are configured to move together as a unit within the driver mechanism housing.
